(19) United States
(12) Patent Application Publication
(10) Pub. No.: US 2006/0291887 A1
(43) Pub. Date: Dec. 28, 2006

(54) Image output method

(75) Inventor: Shing-Chia Chen, Kaohsiung (TW)

Correspondence Address: BIRCH STEWART KOLASCH & BIRCH, PO BOX 747, FALLS CHURCH, VA, 22040-0747, US

(73) Assignee: Avision Inc.

(21) Appl. No.: 11/474,485

(22) Filed: Jun. 26, 2006

(30) Foreign Application Priority Data
Jun. 27, 2005 (TW) 94121505

(51) Int. Cl. G03G 15/00; G03G 21/00

(52) U.S. Cl. 399/75

(57) ABSTRACT

An image output method includes the step of waking up a printing unit and enabling the printing unit to perform a warm-up process while starting a printing control program for the printing unit. Thus, the time of waiting for the printing unit to output image data after a user sends out the image data is shortened.

This application claims the benefit of Taiwan application Serial No. 94121505, filed Jun. 27, 2005, the subject matter of which is incorporated herein by reference.

### BACKGROUND OF THE INVENTION

1. Field of the Invention

The invention relates in general to an image output method, and more particularly to a warm-up method for a printer.

2. Description of the Related Art

In order to save power for the printer, the current printer is often designed such that it automatically enters a so-called power-saving mode (or a sleep-mode) after it idles for a period of time. Thus, the user does not have to turn off the power of the printer momentarily in order to reduce the power consumption of the printer.

When a printing request is transferred to a printer, which is in the power-saving mode, the printer switches to the normal printing mode for performing the printing procedure. FIG. 1 is a flowchart showing an image output method of a conventional printer. First, when the printer is in the power-saving mode, a user interface program UI is started, as shown in step 100. Next, the user finishes the associated settings on the user interface program UI, as shown in step 102. For example, the user sets the image parameters of to-be-printed image data through the interface program UI, and the image parameters include sheet size, image contrast, resolution, and the like. Then, the image data and its image parameters are outputted to the printer, as shown in step 104. For example, the user presses the “Sure” key on the user interface program UI to send the image data and its image parameters to the printer. Next, the printer receives the image data and its image parameters and then starts to execute a warm-up process, which includes the procedures of warm-up and calibration, as shown in step 106. That is, when the “Sure” key on the user interface program UI is pressed, the computer system starts to transfer the warm-up command together with the image data and its image parameters to the printer. The printer receives the warm-up command and then executes the warm-up process so as to switch from the power-saving mode to a printing state. Finally, after the warm-up process is finished, the printer executes the printing procedure according to the image data and its image parameters, as shown in step 108.

In such a design, the user has to wait for the printer to switch from the power-saving mode to the printing state after the user has requested to execute the printing procedure or after the “Sure” key is pressed. However, the waiting time for the printer to switch from the power-saving mode to the printing state is relatively lengthened due to the warm-up and calibration procedures. Especially, the waiting time for the color printer is longer.

### SUMMARY OF THE INVENTION

It is therefore an object of the invention to provide an image output method of shortening the time for a user to wait for an image output under a power-saving mode.

The invention achieves the above-identified object by providing an image output method used in an image outputting system. The image outputting system includes a control device and a printing unit connected to the control device. The image output method includes the steps of: starting a printing control program of the control device to enable the control device to output a warm-up command to the printing unit simultaneously; the printing unit warming up according to the warm-up command; the control device outputting a printing command and image data to the printing unit; and the printing unit printing according to the printing command and the image data.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 (Prior Art) is a flowchart showing an image output method of a conventional printer.

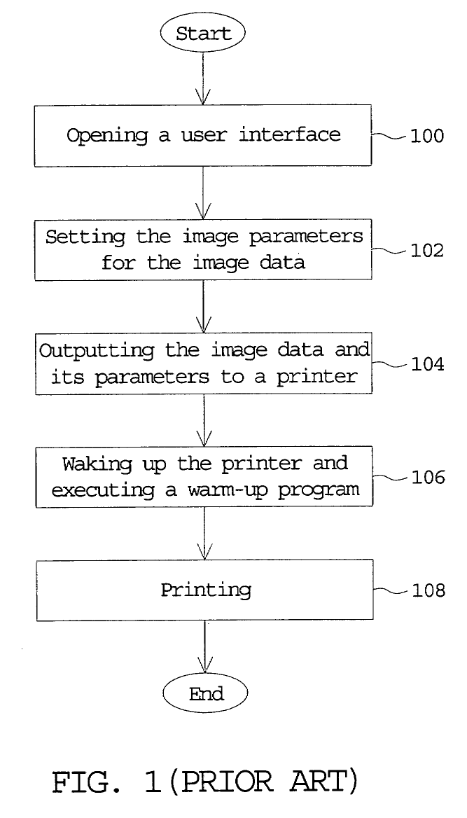

FIG. 2 is a schematic illustration showing an image outputting system.

FIG. 3 is a flowchart showing a warm-up method according to a preferred embodiment of the invention.

FIG. 4 is a schematic illustration showing an example of a printing control program.

FIG. 5 is a schematic illustration showing another example of the printing control program.

### DETAILED DESCRIPTION OF THE INVENTION

The invention provides an image output method of waking up and warming up a printing unit when a printing control program for the printing unit is started in a power-saving mode, such that the time for the user to wait for the printing unit to output image data after the image data is sent out by the user is shortened.

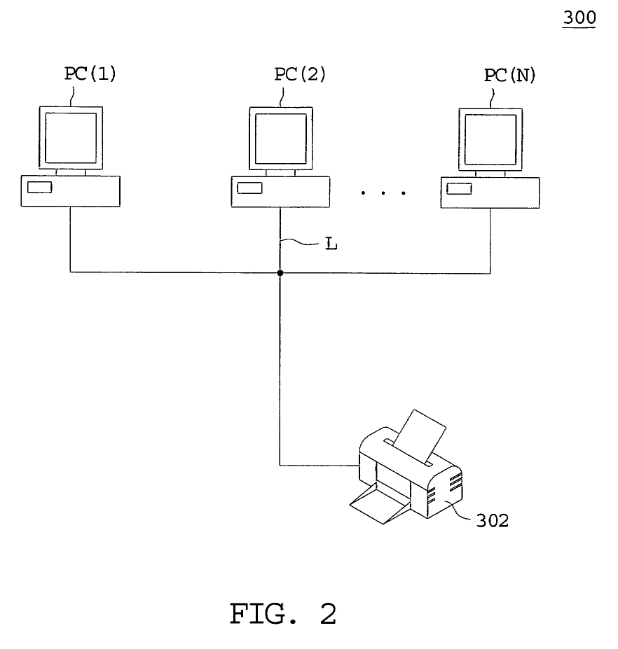

FIG. 2 is a schematic illustration showing an image outputting system. Referring to FIG. 2, an image outputting system 300 includes a printing unit 302 and multiple computers PC(1) to PC(N), wherein N is a positive integer. The computers PC(1) to PC(N) may be, for example desktop computers or notebook computers. The printing unit 302 includes, for example, a printer or a multi-function printer. The printing unit 302 of the embodiment is a printer depicted in FIG. 2. The printer 302 is coupled to the multiple computers PC(1) to PC(N) through a network L. When the computer PC, such as the first computer PC(1), is about to output the image data, the first computer PC(1) transfers the to-be-outputted image data and its image parameters to the printer 302 through the network L, such that the printer 302 outputs the image data.

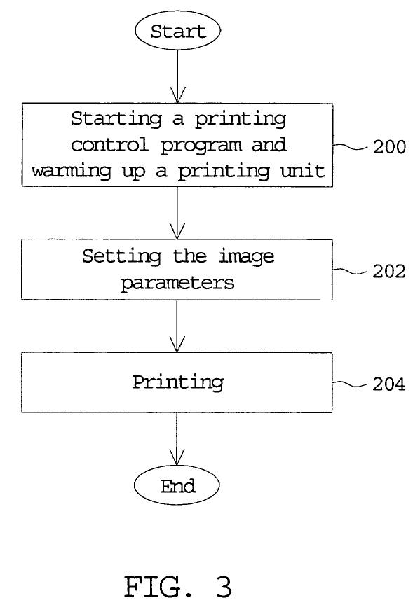

FIG. 3 is a flowchart showing an image output method according to a preferred embodiment of the invention. The image output method of this embodiment is used in the image outputting system 300. The image output method includes the following steps. First, step 200 wakes up the printer 302 and enables the printer 302 to perform a warm-up process when a printing control program, such as the printing control program of the computer PC, is started. Next, step 202 sets the image parameters of the to-be-outputted image data. The image data may be, for example, a word document. The image parameters include, for example, sheet size, layout, resolution, and the like. Finally, step 204 outputs a printing command, the image data and its image parameters to the printer 302 when the image parameters have been completely set. The printer 302 prints out the image data according to the printing command and the image parameters.

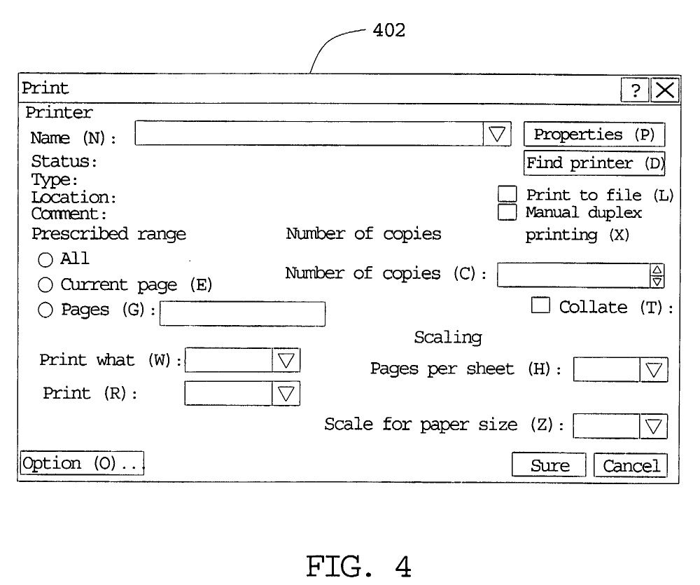

In detail, FIG. 4 is a schematic illustration showing an example of a printing control program. As shown in FIG. 4, illustration will be made by taking the first computer PC(1) and a printing control program 402 as an example. First, when the first computer PC(1) starts the printing control program 402, the driver of the printer 302 coupled to the first computer PC(1) transmits a warm-up command to the printer 302 through the network L. The printer 302 receives the warm-up command, and then the warm-up process is immediately performed if the printer 302 is in the power-saving mode. The warm-up process includes, for example, the warm-up procedure and the calibration procedure so as to switch the power-saving mode to the printing state.

After the printing setting is completed in step 202, step 204 executes a print starting command after the “Sure” key on the printing control program 402 is pressed. The first computer PC(1) outputs a printing command to the printer 302 and outputs the to-be-outputted image data and its image parameters to the printer 302. Because the printer 302 has preformed the warm-up process as the printing control program 402 is started, the printer 302 can directly perform the printing procedure according to the image data and the image parameters if the warm-up process has been completed. Unlike the prior art, in which the printer 302 does not perform the warm-up process until the printing command or the image data and its image parameters are received, the invention can greatly shorten the time for waiting for the printer 302 to print the image data out after the “Sure” key is pressed.

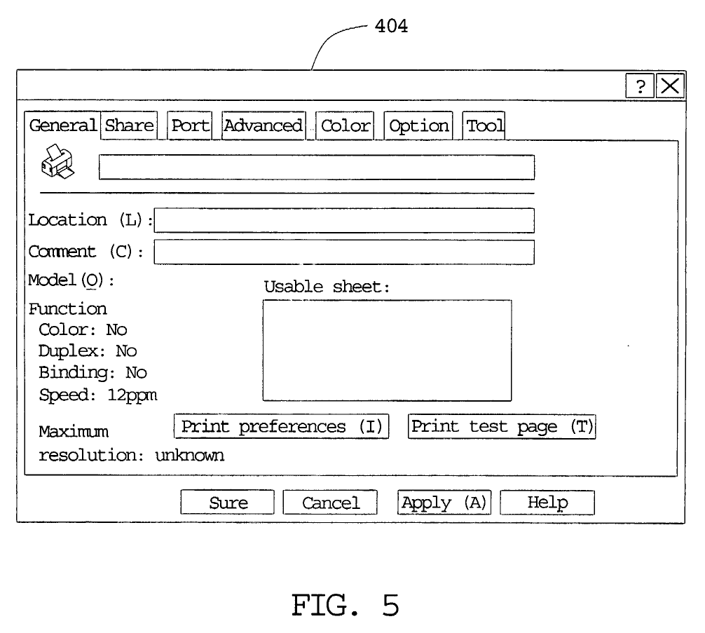

FIG. 5 is a schematic illustration showing another example of the printing control program. When the computer PC(1) starts a printing control program 404 of FIG. 5 to identify the state of the printer 302, as shown in step 200, the driver of the printer 302 transmits the warm-up command from the first computer PC(1) to the printer 302 through the network L. Then, the printer 302 performs the warm-up process. So, after the printer 302 has finished the warm-up process and receives the image data and the image parameters, the printer 302 can perform the printing procedure.

Thus, as long as the printing control program, such as the printing control program 402 of FIG. 4 or the printing control program 404 of FIG. 5, associated to the driver of the printer 302 has been started in any one of the computers PC, the computer PC firstly transmits the warm-up command to the printer 302 to enable the printer 302 to perform the warm-up process so as to shorten the waiting time for warming up the printer after the user has sent the image data.

In addition to the printer, the image output method of the invention may also be applied to a multi-function printer. When the printing unit 302 is the multi-function printer in the power-saving mode, it is possible to wake up the multi-function printer 302 to perform the warm-up process by only starting the printing control program associated to the driver of the multi-function printer 302. So, after the user has set the printing parameters associated to the to-be-printed data, the printing procedure can be directly performed without spending time to wait for the multi-function printer 302 to warm up.

In this embodiment, the type of the control device is not particularly limited. The control device may be a typical personal computer or a micro-controller in the printing unit 302. For example, when the printing unit 302 is the multi-function printer, the printing control program in the computer PC coupled to the multi-function printer 302 is started such that the multi-function printer 302 performs the warm-up process, as mentioned hereinabove.

The invention warms up the printing unit as the user has started the printing control program, so the waiting time from the beginning of the execution of the printing command to the beginning of the printing procedure of the printing unit may be shortened.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image output method used in an image outputting system, which comprises a control device and a printing unit coupled to the control device, the method comprising the steps of:
starting a printing control program of the control device to enable the control device to output a warm-up command to the printing unit simultaneously;
the printing unit warming up according to the warm-up command;
the control device outputting a printing command and an image data to the printing unit; and
the printing unit printing according to the printing command and the image data.

2. The method according to claim 1, wherein the printing control program executes a print starting command to enable the control device to output the printing command and the image data to the printing unit.

3. The method according to claim 1, wherein the control device is a personal computer and the printing unit is a printer.

4. The method according to claim 1, wherein the printing unit is a multi-function printer.

5. The method according to claim 1, wherein the image outputting system is a multi-function printer.
